(19) United States
(12) Patent Application Publication
(10) Pub. No.: US 2005/0193546 A1
(43) Pub. Date: Sep. 8, 2005

(54) Fastener assembly, barrier, and method for assembling of a fastener assembly

(76) Inventors: Paul Gaudron, Stamford, CT (US); Jeffrey Powers, Larchmont, NY (US)

Correspondence Address: CANTOR COLBURN, LLP, 55 GRIFFIN ROAD SOUTH, BLOOMFIELD, CT, 06002, US

(21) Appl. No.: 11/000,746

(22) Filed: Dec. 1, 2004

Related U.S. Application Data
(62) Division of application No. 10/792,182, filed on Mar. 2, 2004.

(51) Int. Cl. F16B 39/30; B23P 19/02

(52) U.S. Cl. 29/525; 29/525.01

(57) ABSTRACT

Disclosed herein is a fastener assembly which includes a fastener, a barrier engaged with the fastener via an aperture, the aperture being configured and dimensioned to create an interference fit with the fastener and a washer having an opening therein, the opening receiving the barrier. Further disclosed herein is a barrier for a fastener and washer where the barrier is described as a barrier comprising a body having one or more outside dimensions calculated to engage an opening in a washer in an interference fit sufficient to retain the washer on the body in an assembly. The body further includes an opening extending at least substantially through the body, the opening in the body having a dimension and configuration to create an interference fit with a fastener.

### BACKGROUND

In the fastening arts there are an uncountable number of methods and assemblies for fastening one thing to another thing. Each of these has its own advantages and many have disadvantages. One fastening configuration and assembly employs a fastener and a washer where the fastener is an axially driven fastener such as a nail or pin.

In some iterations of the fastener and washer combination it is desirable to create a preassembly of the washer and fastener so that the assembly may be applied to a workpiece as an assembly. In these iterations it is known to size an opening in the washer relative to the shank diameter of the fastener such that an interference fit is established between the washer and the fastener. This arrangement has been effective for some time to hold the washer on the fastener and thereby enable handling, loading and dispensing of the fastener/washer assembly. While this assembly is still employed and is effective for its intended purpose, recent developments in fastening applications have required greater corrosion resistance in the fasteners and the washers. Coatings for anticorrosive effect have been added to fasteners and washers to meet challenges of the greater required corrosion resistance. While such coatings are effective if intact, it has been determined that interference fit assemblies, when driven, tend to scrape off the coating and leave the assembly susceptible to corrosion.

### SUMMARY

Disclosed herein is a fastener assembly which includes a fastener, a barrier engaged with the fastener via an aperture, the aperture being configured and dimensioned to create an interference fit with the fastener and a washer having an opening therein, the opening receiving the barrier.

Further disclosed herein is a barrier for a fastener and washer where the barrier is described as a barrier comprising a body having one or more outside dimensions calculated to engage an opening in a washer in an interference fit sufficient to retain the washer on the body in an assembly. The body further includes an opening extending at least substantially through the body, the opening in the body having a dimension and configuration to create an interference fit with a fastener.

Further disclosed herein is a method for assembling a washer/fastener assembly comprising placing a barrier in contact with a washer, installing the barrier in an opening in the washer and urging a fastener into the barrier.

Another method disclosed herein is a method for dispensing a powder driven fastener while protecting a surface coating of a washer and the fastener during the driving of the fastener through the washer. The method includes installing in a washer having an opening and a coating thereon, a barrier configured, dimensioned and positioned to protect the washer from scraping by a fastener driven therethrough, installing a fastener in the barrier such that the fastener is engaged in interference fit with the barrier, and driving the fastener through the barrier and washer while maintaining the fastener and washer out of contact with each other.

### BRIEF DESCRIPTION OF THE DRAWINGS

Referring now to the drawings wherein like elements are numbered alike in the several Figures:

FIG. 1 is a partial cross-sectional view of the fastener/washer assembly;

FIG. 2A is a bottom plan view of a barrier/retainer;

FIG. 2B is a cross-sectional view of the barrier/retainer of FIG. 2A taken along section line 2B-2B;

FIG. 3 is an elevation view of a fastener;

FIG. 4 is a plan view of one embodiment of a washer;

FIG. 5 is a plan view of a second embodiment of a washer; and

FIG. 6 is an alternate assembly partial cross-sectional view.

### DETAILED DESCRIPTION

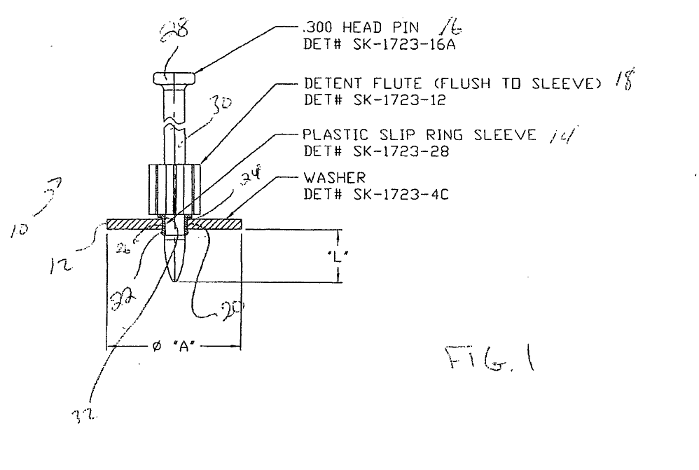

Referring to FIG. 1, an assembly 10 is illustrated comprising washer 12, barrier 14, fastener 16 and detent flute 18. As one of ordinary skill in the art should understand this assembly is illustrated in a condition in which it may be loaded into a fastener driver system such as a powder driven fastener system. In this condition the barrier 14 may be maintained within an opening 20 in washer 12 by friction due to an interference fit or by at least one detent 22. Further, in one embodiment, barrier 14 includes a flange 24 extending radially outwardly from a body 26 of barrier 14. The flange ensures that the head 28 of fastener 16 does not impact a top surface of the washer 12 sufficiently to remove the anti-corrosive material thereby creating a barrier in that location as well. In the event that a detent 22 is utilized to retain barrier 14 within the opening 20 of washer 12, the flange 24 will provide a counter balancing holding effect. The fastener 16 includes a fastener head 28 and a fastener shank 30 which extends in the assembled form through an aperture 32 in barrier 14 that opening being configured, positioned and dimensioned to hold fastener shank 30 in a interference fit arrangement such that the fastener shank 30 is maintained in a selected position in the assembly with sufficient force to allow handling and loading of the assembly 10 as required. The cross-sectional geometrical configuration of the aperture 32 may be identical to the shank 30 of fastener 16 and may be in any geometric shape. Aperture 32 may also be in a geometric shape different from that of shank 30 providing that the retention of fastener 16 as above stated is maintained.

It is further noted that the cross-sectional geometric configuration on the outside surface of barrier 14 may be of any geometric shape and may match or mismatch with the geometric shape of the opening 20 in washer 12. In the event that the particular embodiment includes a barrier 14 which is held within washer opening 20 by interference fit, the geometric shapes and sizes should be selected to provide such an interference fit.

Barrier 14 has two purposes within assembly 10. One purpose has already been introduced and that is that it is intended to maintain fastener shank 30 as an assembled form within washer 12. The second function of barrier 14 is to prevent frictional action between shank 30 and washer 12 during driving of fastener 16 that would otherwise scrape off an anti-corrosive coating. Barrier 14 prevents direct interaction between shank 30 and the opening 20 of washer 12 whereby the corrosion resistant coating on each of these components is not scraped from the component during the driving action on the fastener and therefore the components are not made susceptible to the corrosive environment in which they are to be employed. Barrier 14 may be constructed of any material having property sufficient to retain the fastener yet prevent scraping off of the anti-corrosive coating from the fastener or washer. In one embodiment the barrier is plastic which may be a unitary piece of plastic. Further, the barrier material may be a lubricious material.

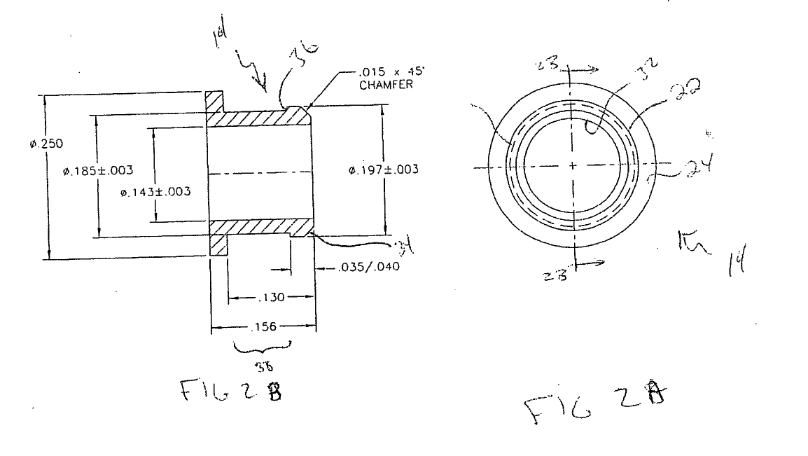

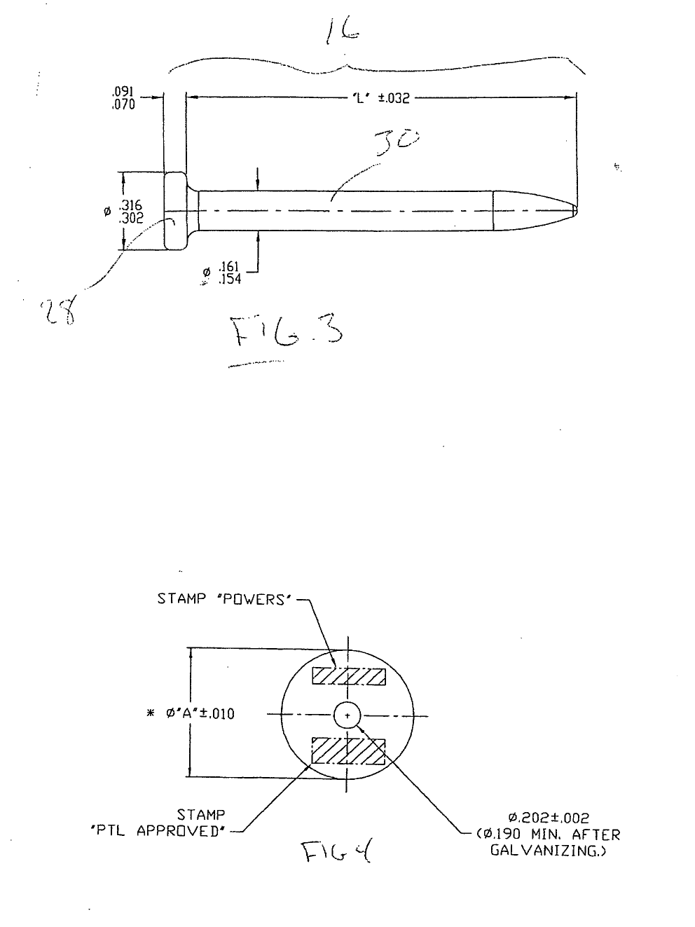

Referring to FIGS. 2A and 2B one embodiment of barrier 14 is illustrated on its own. It will be apparent to one of ordinary skill in the art at least from FIG. 2A that this particular embodiment of barrier 14 employs a cylindrical cross-sectional geometric configuration on both its outside dimension and its inside dimension. As was stated earlier, the outside dimension or the inside dimension may be different from cylindrical in shape and in addition the inside geometric shape and the outside geometric shape need not be the same providing that the goals of the barrier device are served i.e., with retention of the fastener within the washer and non-contact of the fastener with the washer. The embodiment illustrated in FIG. 2A includes at least one detent 22 which is illustrated as a continuous ridge in this drawing but of course may be a broken ridge thereby defining multiple detents, if desired. The internal dimension of aperture 32 will as noted above be sized appropriately to provide an interference fit with shaft 30 of fastener 16 inserted therein. As is best seen in FIG. 2B, this embodiment of barrier 14 includes a chamfer 34 which is intended to aid insertion of the barrier 14 into washer 12. In a location opposed to chamfer 34 is a detent edge 36 which will in effect be at least parallel to if not a backward angle to a surface of washer 12 thereby retaining barrier 14 within washer 12 once it has been inserted therein. One of ordinary skill in the art will appreciate that the barrier 14 illustrated in FIG. 2B has a body length 38 which will be substantially equivalent to the thickness of the washer intended therefore. It will also be appreciated by one of ordinary skill in the art that a washer having a thickness less than length 38 could be employed with the barrier 14 however it may then be that barrier 14 is slightly obstructive to proper seating of washer 12 against a workpiece.

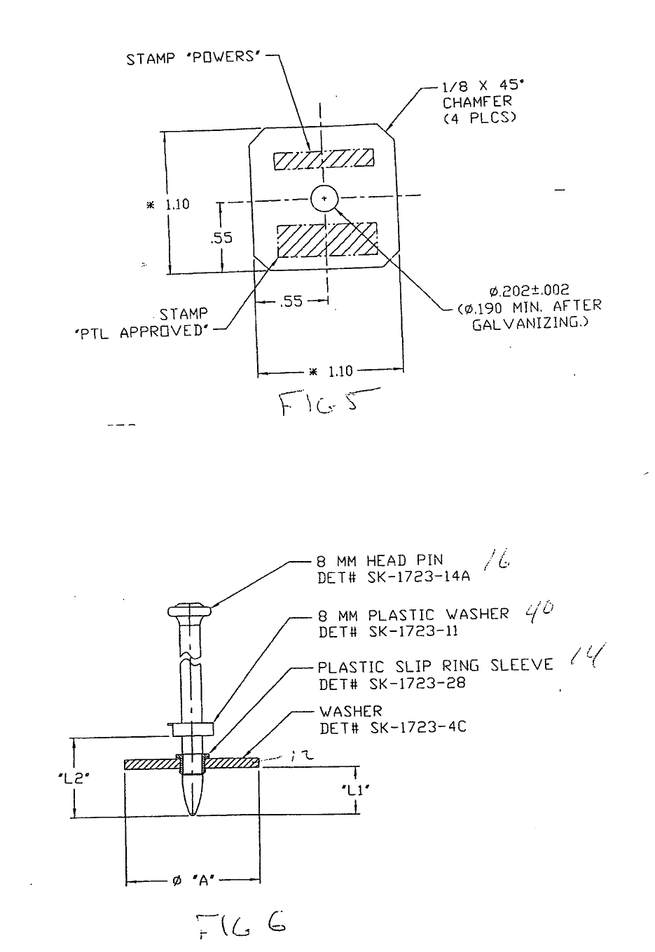

FIGS. 4 and 5 are provided to illustrate differing washers that may be employed. It will be understood by one of ordinary skill in the art that although circular and chamfered corner square washers are illustrated in FIGS. 4 and 5 any geometric shape of washer may be employed with the assembly as described herein.

Referring to FIG. 6, an alternate embodiment assembly is illustrated in assembled form having washer 12, barrier 14, fastener 16 and a collar 40 in place of the detent flute 18.

While preferred embodiments have been shown and described, modifications and substitutions may be made thereto without departing from the spirit and scope of the invention. Accordingly, it is to be understood that the present invention has been described by way of illustrations and not limitation.

1-14. (canceled)

15. A method for assembling a washer/fastener assembly comprising:
placing a barrier in contract with a washer;
installing the barrier in an opening in the washer; and
urging a fastener into the barrier.

16. A method for assembling a washer/fastener assembly as claimed in claim 15 wherein said installing the barrier in the opening in the washer utilizes an interference fit.

17. A method for assembling a washer/fastener assembly as claimed in claim 15 wherein said urging is against an interference fit contact.

18. A method for dispensing a powder driven fastener while protecting a surface coating of a washer and the fastener during the driving of the fastener through the washer comprising:
installing in a washer having an opening and a coating thereon, a barrier configured, dimensioned and positioned to protect the washer from scraping by a fastener driven therethrough;
installing a fastener in the barrier such that the fastener is engaged in interference fit with the barrier; and
driving the fastener through the barrier and washer while maintaining the fastener and washer out of contact with each other.
